(19) United States
(12) Patent Application Publication
(10) Pub. No.: US 2024/0127157 A1
(43) Pub. Date: Apr. 18, 2024

(54) UPDATE INFORMATION GENERATION APPARATUS, QUALIFICATION INFORMATION MANAGEMENT SYSTEM, UPDATE INFORMATION GENERATION METHOD, AND COMPUTER READABLE MEDIUM

(71) Applicant: NEC Corporation, Minato-ku, Tokyo (JP)

(72) Inventors: Takuya NOMURA, Tokyo (JP); Takuya HISAMOTO, Tokyo (JP); Kenichi KIJIMA, Tokyo (JP)

(73) Assignee: NEC Corporation, Minato-ku, Tokyo (JP)

(21) Appl. No.: 18/278,289

(22) PCT Filed: Jan. 13, 2022
(86) PCT No.: PCT/JP2022/000974

§ 371 Date: Aug. 22, 2023

(30) Foreign Application Priority Data
Mar. 31, 2021 (JP) 2021-062051

(51) Int. Cl. G06Q 10/0639

(52) U.S. Cl. CPC G06Q 10/0639

(57) ABSTRACT

An update information generation apparatus includes at least one memory configured to store dynamic information on a qualification regarding a mobile body and instructions, and at least one processor configured to execute the instructions to acquire plan information regarding an operation plan for operating the mobile body, acquire achievement information that corresponds to the plan information of the mobile body, calculate an evaluation score for updating static information on the qualification based on the dynamic information, the plan information, and the achievement information, and output update information including the evaluation score and an identifier to a static information management apparatus that manages the static information.

### TECHNICAL FIELD

The present invention relates to an update information generation apparatus, a qualification information management system, an update information generation method, and a computer readable medium.

### BACKGROUND ART

Mobile bodies such as unmanned aircrafts, autonomous robots, or self-driving vehicles that move autonomously or by remote control have become more and more widespread. Further, it is expected that a technique for safely operating these mobile bodies will be developed.

With regard to the above matters, a method, for example, in which, when it is being determined whether or not a user is permitted to operate an unmanned aircraft, information regarding a type of a user (e.g., a degree of skill, a level of experience, certification, a license, or training), is taken into account has been proposed (Patent Literature 1).

Further, a technique for determining an operator's skill based on an acquired operation history and a specified specific event period is disclosed (Patent Literature 2).

### CITATION LIST

### Patent Literature

[Patent Literature 1] Japanese Unexamined Patent Application Publication No. 2019-064584
[Patent Literature 2] Japanese Unexamined Patent Application Publication No. 2020-067587

### SUMMARY OF INVENTION

### Technical Problem

The aforementioned techniques indicate aspects for managing a manipulation qualification regarding a mobile body, or other people who are involved in the operation of the mobile body. However, it is required that these qualifications be efficiently managed in view of situations of a society or the like.

The present disclosure has been made in view of the aforementioned problem, and an object of the present disclosure is to provide an update information generation apparatus, a qualification information management system, an update information generation method, and a program for suitably managing qualification information.

### Solution to Problem

An update information generation apparatus according to one example embodiment of the present disclosure includes a dynamic information storage unit, a plan information acquisition unit, an achievement information acquisition unit, a calculation unit, and an output unit. The dynamic information storage unit stores dynamic information on a qualification regarding a mobile body. The plan information acquisition unit acquires plan information regarding an operation plan for operating the mobile body. The achievement information acquisition unit acquires achievement information that corresponds to the plan information of the mobile body. The calculation unit calculates an evaluation score for updating static information on the qualification based on the dynamic information, the plan information, and the achievement information. The output unit outputs update information including the evaluation score and an identifier to a static information management apparatus that manages the static information.

In an update information generation method according to one example embodiment of the present disclosure, a computer executes the following method. The computer stores dynamic information on a qualification regarding a mobile body. The computer acquires plan information regarding an operation plan for operating the mobile body. The computer acquires achievement information that corresponds to the plan information of the mobile body. The computer calculates an evaluation score for updating static information on the qualification based on the dynamic information, the plan information, and the achievement information. The computer outputs update information including the evaluation score and an identifier to a static information management apparatus that manages the static information.

A program according to one example embodiment of the present disclosure causes a computer to execute the following steps. The computer stores dynamic information on a qualification regarding a mobile body. The computer acquires plan information regarding an operating plan of the mobile body. The computer acquires achievement information that corresponds to the plan information of the mobile body. The computer calculates an evaluation score for updating static information on the qualification based on the dynamic information, the plan information, and the achievement information. The computer outputs update information including the evaluation score and an identifier to a static information management apparatus that manages the static information.

### Advantageous Effects of Invention

According to the present disclosure, it is possible to provide an update information generation apparatus, a qualification information management system, an update information generation method, and a program for suitably managing qualification information.

### BRIEF DESCRIPTION OF DRAWINGS

FIG. 1 is a block diagram of an update information generation apparatus according to a first example embodiment;

FIG. 2 is a flowchart of an update information generation method according to the first example embodiment;

FIG. 3 is a block diagram of a qualification information management system according to a second example embodiment;

FIG. 4 is a block diagram of an update information generation apparatus according to the second example embodiment;

FIG. 5 is a block diagram of a static information management apparatus according to the second example embodiment;

FIG. 6 is a block diagram of a mobile body according to the second example embodiment;

FIG. 7 is a diagram showing an example of dynamic information;

FIG. 8 is a diagram showing an example of static information;

FIG. 9 is a diagram showing an example of remote identification information;

FIG. 10 is a flowchart of an update direction according to the second example embodiment;

FIG. 11 is a flowchart of a static information managing direction according to the second example embodiment; and

FIG. 12 is a block diagram illustrating a hardware configuration of a computer.

### EXAMPLE EMBODIMENT

Hereinafter, the present disclosure will be described based on embodiments of the present disclosure. However, the disclosure set forth in claims is not limited to the following embodiments. Moreover, it is not absolutely necessary to provide all the configurations to be described in the following embodiments as means for solving the problems. For the sake of clarification of the description, the following description and the drawings are partially omitted and simplified as appropriate. Throughout the drawings, the same symbols are attached to the same elements and overlapping descriptions are omitted as necessary.

### First Example Embodiment

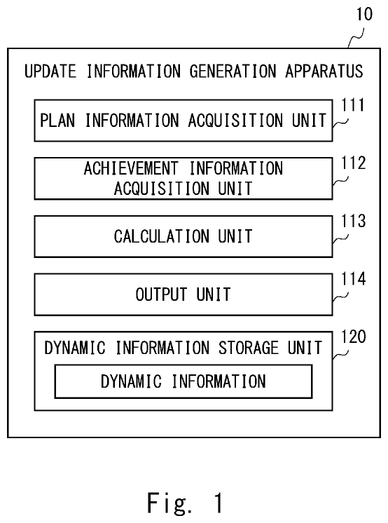

Hereinafter, with reference to the drawings, example embodiments of the present invention will be described. FIG. 1 is a block diagram of an update information generation apparatus 10 according to a first example embodiment. The update information generation apparatus 10 shown in FIG. 1 is connected to a predetermined mobile body in such a manner that they can communicate with each other. Further, the update information generation apparatus 10 supplies, in order to cause an apparatus that evaluates a qualification regarding the mobile body and manages information regarding the qualification to update information regarding the qualification, update information including an evaluation score regarding this evaluation.

The mobile body according to the present disclosure is, for example, a mobile body that moves by remote manipulation or a mobile body that autonomously moves under a predetermined management. More specifically, the mobile body may include an unmanned aircraft, a self-driving car, an autonomous mobile robot, or a ship, a construction vehicle, a walking robot or the like that moves autonomously or by remote control.

Further, in the present disclosure, the qualification regarding the mobile body includes a qualification (license) for manipulating or using the aforementioned mobile body, a qualification (authorization) for owning or managing the mobile body, an operation qualification (operation permission) for operating the mobile body itself, or the like. The qualification for manipulating or using the mobile body is granted to a user. The qualification for owning or managing the mobile body is granted to an administrator. The operation qualification for operating the mobile body itself is granted to the mobile body.

The update information generation apparatus 10 mainly includes a plan information acquisition unit 111, an achievement information acquisition unit 112, a calculation unit 113, an output unit 114, and a dynamic information storage unit 120.

The plan information acquisition unit 111 acquires plan information from an administrator or a user of the mobile body. The plan information, which is information regarding an operation plan for operating the mobile body, includes, for example, the time and date, the period, the place, the purpose or the like for operating the mobile body.

The achievement information acquisition unit 112 acquires achievement information that corresponds to the plan information of the mobile body. The achievement information is information indicating the achievement of the mobile body actually operated. The achievement information includes, for example, the time and date when the mobile body moved, position information, the moving speed or the like. This achievement information may be information generated by a sensor included in a mobile body or a control apparatus that controls the mobile body when the mobile body is being operated under a predetermined plan. When the mobile body includes a camera, for example, the achievement information may be information on an image captured by the camera.

The calculation unit 113 calculates the evaluation score using the plan information received from the plan information acquisition unit 111, the achievement information received from the achievement information acquisition unit 112, and dynamic information that will be described later. The evaluation score is used to update predetermined information regarding the qualification regarding the mobile body. The predetermined information regarding the qualification regarding the mobile body includes, for example, information regarding a validity period of the qualification or information indicating the validity of the qualification. The aforementioned information may also be referred to as static information on the qualification.

The dynamic information according to the present disclosure is information that may vary, when the mobile body is operated, in accordance with the operation of the mobile body. The dynamic information includes, for example, a total operation time, a failure history, an accident history, or an operation history of the mobile body. Further, the dynamic information includes the aforementioned evaluation score. The dynamic information is accumulated for the purpose of updating the static information.

Further, the static information according to the present disclosure is information that is used to manage a qualification regarding the mobile body. The static information includes, for example, the user's name or address, the name or the title of the administrator, a unique identifier of the mobile body, or the like. Further, the static information includes information regarding the validity of the qualification. The information regarding the validity of the qualification is, for example, information indicating a validity period of the qualification, the time and the date of update, or the validity itself. The information regarding the validity of the qualification may include, for example, a rank or a type indicating the content of the operations permitted by the qualification, such as an operation range of the mobile body or the purpose of the operation by the mobile body.

The output unit 114 receives the evaluation score from the calculation unit 113 and outputs update information including the received evaluation score to the static information management apparatus. The static information management apparatus and the update information generation apparatus 10 are connected to each other in such a manner that they can communicate with each other. The update information is information for updating static information managed by the static information management apparatus. The update information includes an evaluation score and an identifier. The identifier is associated with the evaluation score. Further, the identifier is set so as to be associated with the predetermined static information. That is, the evaluation score and the static information are associated with each other via this identifier.

The dynamic information storage unit 120, which is a storage apparatus including a non-volatile memory such as a flash memory or a Solid State Drive (SSD), stores the aforementioned dynamic information. The dynamic information storage unit 120 supplies the dynamic information to be stored to the calculation unit 113.

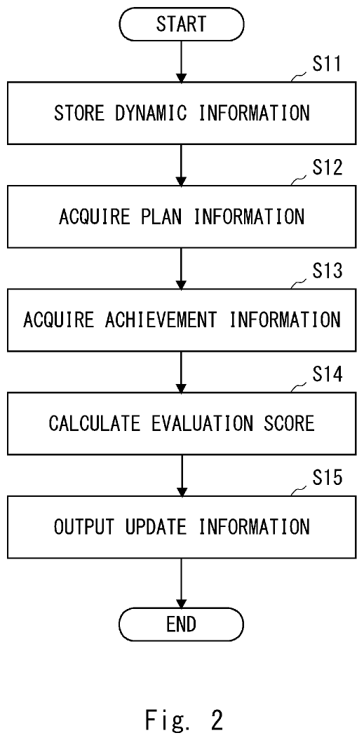

Referring next to FIG. 2, processing executed by the update information generation apparatus 10 will be described. FIG. 2 is a flowchart of an update information generation method according to the first example embodiment. The processing in the flowchart shown in FIG. 2 is started, for example, when the update information generation apparatus 10 is started. Alternatively, the flowchart shown in FIG. 2 may be started when predetermined information is received from a mobile body.

First, the dynamic information storage unit 120 stores dynamic information on a qualification regarding the mobile body (Step S11). The dynamic information storage unit 120 receives, from the mobile body that is being operated, dynamic information regarding this operation and stores the received dynamic information. When the mobile body includes a plurality of times of operation achievement, the dynamic information storage unit 120 stores dynamic information when the mobile body was operated last time. Further, when the mobile body has been newly operated, the dynamic information storage unit 120 updates or accumulates the dynamic information and stores this dynamic information.

Next, the plan information acquisition unit 111 acquires plan information regarding an operation plan for operating the mobile body (Step S12). The plan information acquisition unit 111 acquires plan information from, for example, the administrator of the mobile body. Upon acquiring the plan information, the plan information acquisition unit 111 supplies the acquired plan information to the calculation unit 113.

Next, the achievement information acquisition unit 112 acquires achievement information that corresponds to the plan information of the mobile body (Step S13). The achievement information acquisition unit 112 sequentially acquires, from the mobile body which is in operation, achievement information that is generated during the operation. Alternatively, the achievement information acquisition unit 112 may acquire, from a mobile body that has ended an operation, achievement information regarding a series of operations. The achievement information acquisition unit 112 supplies the acquired achievement information to the calculation unit 113.

Next, the calculation unit 113 calculates an evaluation score for updating static information on the qualification using the dynamic information, the plan information, and the achievement information (Step S14). The calculation unit 113 calculates, after a series of operations of the mobile body are ended, an evaluation score regarding the series of operations. After the calculation unit 113 calculates the evaluation score, the calculation unit 113 supplies the calculated evaluation score to the output unit 114.

The output unit 114 outputs update information including the evaluation score and the identifier to a static information management apparatus (Step S15). After the output unit 114 outputs the update information, the update information generation apparatus 10 ends the series of processing.

The update information generation apparatus 10 according to the first example embodiment has been described above. It can also be said that the dynamic information and the static information according to the present disclosure are information regarding a qualification regarding the mobile body (qualification information). That is, the update information generation apparatus 10 generates update information for updating the qualification information.

Note that the update information generation apparatus 10 includes, as components that are not shown, a processor and a storage apparatus. The storage apparatus included in the update information generation apparatus 10 includes, for example, a storage apparatus including a non-volatile memory such as a flash memory or an SSD. In this case, the storage apparatus included in the update information generation apparatus 10 stores a computer program (hereinafter it may also be simply referred to as a program) for executing the aforementioned update information generation method. Further, the processor causes a computer program to be loaded to a buffer memory such as a Dynamic Random Access Memory (DRAM) from the storage apparatus, and executes this program.

Each of the components of the update information generation apparatus 10 may be implemented by special-purpose hardware. Further, some or all of the components of each component may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as a processor. The descriptions regarding the components described here may also be applied to other apparatuses or systems that will be described below in the present disclosure.

Further, when some or all of the components of the update information generation apparatus 10 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the update information generation apparatus 10 may be provided in the form of Software as a Service (SaaS).

The first example embodiment has been described above. According to the first example embodiment, it is possible to provide an update information generation apparatus and the like for suitably managing qualification information.

### Second Example Embodiment

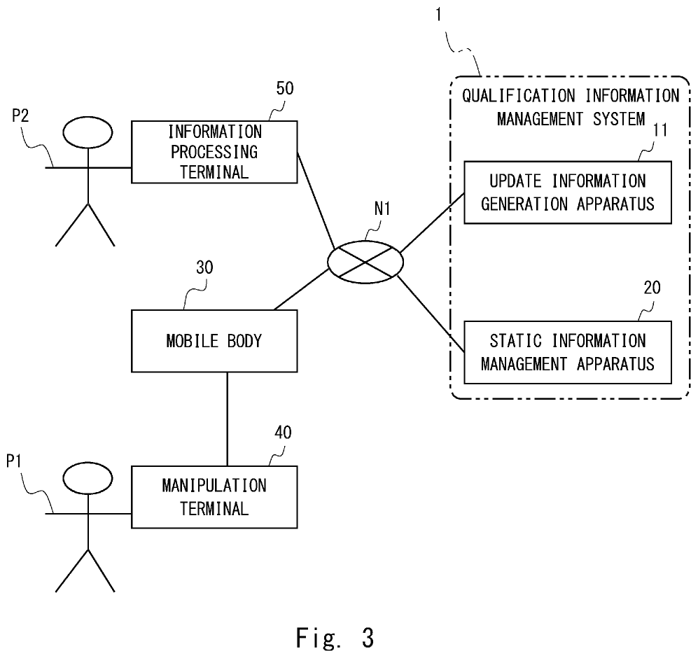

Next, a second example embodiment will be described. FIG. 3 is a block diagram illustrating a configuration of a qualification information management system according to a second example embodiment. A qualification information management system 1 shown in FIG. 3 is connected to a mobile body 30, which is a mobile body, via a network N1 in such a manner that they can communicate with each other. The mobile body 30 is one example aspect of a mobile body according to the present disclosure. Further, the qualification information management system 1 is connected to an information processing terminal 50 via the network N1 in such a manner that they can communicate with each other. The qualification information management system 1 acquires plan information regarding an operation plan for operating the mobile body 30 from the information processing terminal 50. Further, the qualification information management system 1 acquires achievement information that corresponds to the plan information received from the information processing terminal 50 from the mobile body 30 via the network N1. Note that the qualification information management system 1 may acquire the plan information regarding the operation plan from a manipulation terminal 40.

Upon receiving the plan information and the achievement information, the qualification information management system 1 updates information regarding the operation qualification for operating the mobile body 30 from the received information. The qualification information management system 1 may transmit the updated information or qualification information regarding this updated information to the information processing terminal 50. Accordingly, the qualification information management system 1 is able to notify the user of the updated qualification information as appropriate.

The qualification information management system 1 includes an update information generation apparatus 11 and a static information management apparatus 20. The update information generation apparatus 11 and the static information management apparatus 20 are connected to each other via, for example, the network N1, in such a way that they can communicate with each other. The update information generation apparatus 11 acquires plan information from the information processing terminal 50, acquires achievement information that corresponds to the plan information from the mobile body 30, and supplies update information generated in accordance with these information items to the static information management apparatus 20. The static information management apparatus 20 updates the static information using the update information received from the update information generation apparatus 11.

The mobile body 30 is an unmanned aircraft that can be remotely controlled. The mobile body 30 receives an instruction from the manipulation terminal 40 operated by a user P1 and performs an operation such as a movement in accordance with the received instruction. The mobile body 30 is configured to move while periodically (e.g., every second) sending predetermined remote identification information. The remote identification information includes information that is necessary for the mobile body 30 to move, such as identification information of the mobile body 30 or information regarding qualification or permission for moving. Further, the remote identification information may include achievement information such as position information on the mobile body 30 or a moving time thereof. The mobile body 30 transmits remote identification information to the qualification information management system 1 via the network N1.

The manipulation terminal 40, which is a device for remotely controlling the mobile body 30, is able to send an instruction via wireless communication for causing the mobile body 30 to perform a predetermined motion. The manipulation terminal 40 may acquire data or the like of a sensor included in the mobile body 30. The manipulation terminal 40 may be able to transmit predetermined data to the qualification information management system 1 without the intervention of the mobile body 30. Further, the manipulation terminal 40 may transmit predetermined data to the qualification information management system 1 via the mobile body 30.

The information processing terminal 50 is a computer owned by an administrator P2 who manages and operates a plurality of mobile bodies including the mobile body 30. The information processing terminal 50 is able to transmit information regarding the moving plan of the mobile body to the qualification information management system 1 via the network N1. That is, when the administrator P2 moves the mobile body managed by the administrator P2, the administrator P2 sends the moving plan to the qualification information management system 1 in advance. The moving plan includes plan information such as a purpose of moving, a moving area, or a moving time of the mobile body.

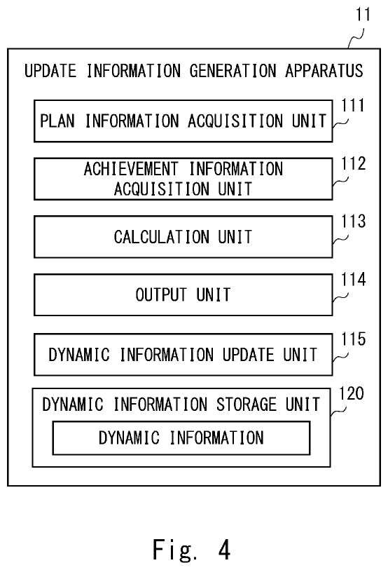

Referring to FIG. 4, the update information generation apparatus 11 according to this example embodiment will be described. FIG. 4 is a block diagram of the update information generation apparatus 11 according to the second example embodiment. The update information generation apparatus 11 is different from the update information generation apparatus 10 according to the first example embodiment in that the update information generation apparatus 11 further includes a dynamic information update unit 115.

The dynamic information update unit 115 updates the dynamic information stored in the dynamic information storage unit 120. Specifically, upon receiving the achievement information from the mobile body 30, the dynamic information update unit 115 may update the information corresponding to the dynamic information as dynamic information from the received achievement information. For example, when the dynamic information update unit 115 has acquired information on the total moving time from the mobile body 30, the dynamic information update unit 115 causes the dynamic information storage unit 120 to store the acquired information on the total moving time. Further, the dynamic information update unit 115 stores the evaluation score calculated by the calculation unit 113 in the dynamic information storage unit 120 as dynamic information. Therefore, when the calculation unit 113 has newly calculated an evaluation score, the dynamic information update unit 115 causes the dynamic information storage unit 120 to store this evaluation score.

The dynamic information storage unit 120 according to this example embodiment stores dynamic information including user information regarding a usage achievement of the user P1 who has a usage qualification for using the mobile body. In accordance therewith, the calculation unit 113 calculates an evaluation score of the user P1.

Further, the dynamic information storage unit 120 may store dynamic information including administrator information regarding a managing achievement of the administrator P2 who has a management qualification regarding the mobile body 30. In this case, the calculation unit 113 may calculate an evaluation score of the administrator P2.

Further, the dynamic information storage unit 120 may store dynamic information including a mobile body score regarding an operation qualification for operating the mobile body 30. In this case, the calculation unit 113 may calculate an evaluation score of the mobile body 30.

The calculation unit 113 according to this example embodiment may update an evaluation score with a value that becomes higher as the difference between the plan information and the achievement information becomes smaller, and update an evaluation score with a value that becomes lower as the difference between the plan information and the achievement information becomes larger. Accordingly, the update information generation apparatus 11 is able to suitably calculate an evaluation score by dynamic information.

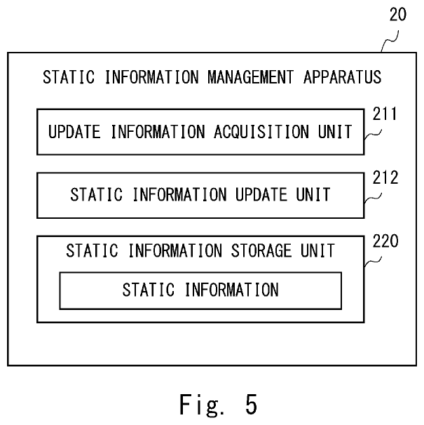

Referring next to FIG. 5, the static information management apparatus 20 will be described. FIG. 5 is a block diagram of the static information management apparatus 20 according to the second example embodiment. The static information management apparatus 20 shown in FIG. 5 mainly includes an update information acquisition unit 211, a static information update unit 212, and a static information storage unit 220.

The update information acquisition unit 211 acquires update information supplied from the update information generation apparatus 11 via the network N1. The update information acquisition unit 211 supplies the acquired update information to the static information update unit 212.

The static information update unit 212 updates static information regarding the corresponding identifier from the evaluation score received from the update information acquisition unit 211. The static information storage unit 220 stores static information on the qualification.

In the static information management apparatus 20, the static information storage unit 220 may store static information including a validity period of a qualification. In this case, the static information update unit 212 may update the validity period of the qualification included in the static information from the acquired evaluation score. Accordingly, the qualification information management system 1 is able to change the validity period of the qualification in accordance with the evaluation score.

Assume, for example, the user P1 who manipulates the mobile body 30 has performed a dangerous manipulation. In this case, the update information generation apparatus 11 may set the evaluation score of the user P1 to a relatively low value in accordance with the dangerous manipulation. Then, the static information management apparatus 20 that has received the evaluation score having a relatively low value shortens the validity period of the qualification of the user, which is included in the static information regarding the user P1, and updates the validity period with the new one.

It is further assumed, for example, that the administrator P2 has used, for an actual operation, a body that is different from a body registered when the operation plan has been sent. In this case, the update information generation apparatus 11 may set the evaluation score of the administrator P2 to a relatively low value. Then the static information management apparatus 20 that has received the evaluation score having a relatively low value shortens the validity period of the qualification of the administrator, which is included in the static information regarding the administrator P2, and updates the validity period with the new one.

It is further assumed, for example, that the total operation time of the mobile body 30 has become relatively long and ages. In this case, the update information generation apparatus 11 may set the evaluation score of the mobile body 30 to a relatively low value. Then, the static information management apparatus 20 that has received the evaluation score having a relatively low value shortens the validity period of the qualification regarding the mobile body, which is included in the static information regarding the mobile body 30, and updates the validity period with the new one.

Further, for example, the static information management apparatus 20 may extend the aforementioned validity period of the qualification and update the validity period with a new one in a case where, for example, it has received a relatively high evaluation score or a case where it has not received a low evaluation score within a predetermined period.

Further, the static information management apparatus 20 may store a preset first threshold and a preset second threshold as thresholds regarding the evaluation score. In this case, when the evaluation score is equal to or larger than the first threshold, the static information update unit 212 may extend the validity period, while when the evaluation score is smaller than a second threshold lower than the first threshold, the static information update unit 212 may shorten the validity period. According to this configuration, the qualification information management system 1 is able to suitably update the static information regarding the validity period.

Further, in the static information management apparatus 20, the static information storage unit 220 may store static information including the validity of the qualification and the static information update unit 212 may update information indicating whether or not the qualification is valid based on the evaluation score. For example, when the user P1 has flown the mobile body 30 into an entry prohibited area without permission, the update information generation apparatus 11 that has received the achievement information from the mobile body 30 significantly reduces the value of the evaluation score. Then the static information management apparatus 20 that has received the update information including the evaluation score that has been significantly reduced updates the static information in accordance with this evaluation score. Specifically, for example, the static information management apparatus 20 changes the state of the qualification of the user P1 who manipulates the mobile body 30 from valid to invalid and updates the state of the qualification. In this manner, the qualification information management system 1 is able to suitably update whether or not the qualification is valid.

Further, the static information management apparatus 20 may store a preset third threshold as a threshold regarding the evaluation score. In this case, the static information update unit 212 may update information with information indicating that the qualification is invalid when the evaluation score is smaller than the third threshold.

In the static information management apparatus 20, the static information storage unit 220 may store static information for dividing the qualification into classes. The class in this case indicates, for example, a level of difficulty of the operation in an environment in which the user P1 operates the mobile body 30. That is, for example, in one class (e.g., a class A), an operation under an environment in which a more difficult operation is required is permitted, whereas in another class (e.g., a class B), the operation under the environment in which a difficult operation is required is not permitted. In this case, the static information update unit 212 may change the class of the qualification included in the static information from, for example, the class A to the class B, or from the class B to the class A in accordance with the acquired evaluation score. Likewise, this class may indicate, for example, the level of difficulty or particularity of an operation in a condition in which the administrator P2 manages the mobile body 30. Further, this class may indicate, for example, the level of difficulty or particularity of the operation that can be executed by the mobile body 30 itself.

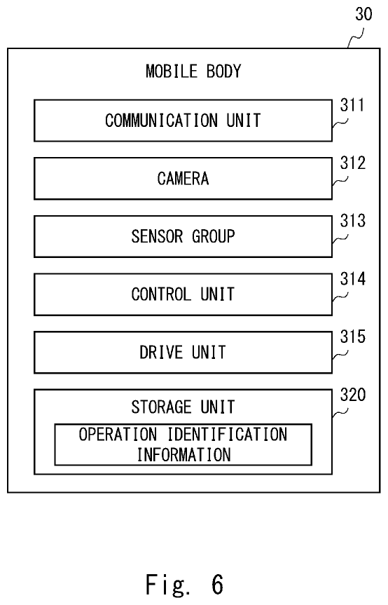

Referring next to FIG. 6, the mobile body 30 will be described. FIG. 6 is a block diagram of the mobile body 30 according to the second example embodiment. The mobile body 30 mainly includes a communication unit 311, a camera 312, a sensor group 313, a control unit 314, a drive unit 315, and a storage unit 320.

The communication unit 311 includes an interface for enabling connection with the manipulation terminal 40 wirelessly, and an interface for enabling connection with the qualification information management system 1 wirelessly. The camera 312 captures an image of surroundings for each preset period while the mobile body 30 is moving, and generates image data regarding the captured images. The image data regarding the images captured by the camera 312 is supplied to the manipulation terminal 40 via the communication unit 311. Further, this image data may be transmitted to the qualification information management system 1 as remote identification information. The sensor group 313 indicates various sensors included in the mobile body 30. The sensor group 313 may include, for example, an antenna that acquires position information by a Global Navigation Satellite System (GNSS), a gyro sensor, a thermometer, a hygrometer or the like.

The control unit 314 includes a computation apparatus such as a CPU or an MCU and controls each of the components included in the mobile body 30. The drive unit 315, which is driven to enable the mobile body 30 to move, includes, for example, a motor for rotating a propeller used when the mobile body 30 moves. The storage unit 320, which is a storage apparatus including a non-volatile memory such as a flash memory or an SSD, at least stores remote identification information.

### (Dynamic Information)

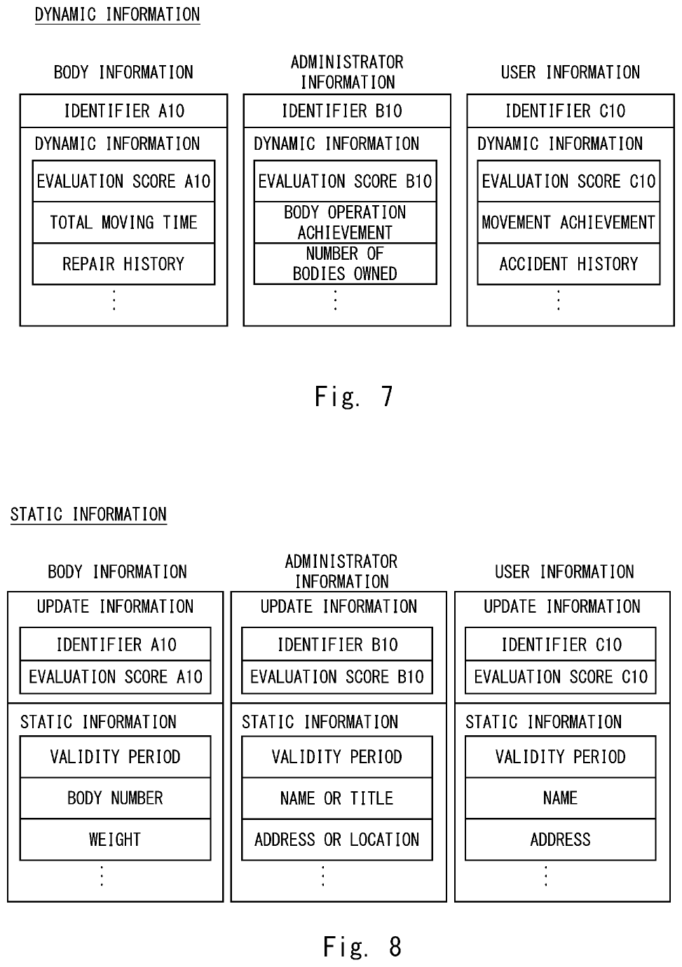

Referring next to FIG. 7, the dynamic information stored in the update information generation apparatus 11 will be described. FIG. 7 is a diagram showing an example of the dynamic information. The dynamic information shown in FIG. 7 includes each of body information, administrator information, and user information.

The body information includes an identifier A10, and dynamic information of the body information. The identifier A10 indicates that the body information associated with the identifier A10 is information regarding the mobile body 30. The dynamic information of the body information includes an evaluation score A10 regarding the body, a total moving time, a repair history, and the like.

The administrator information includes an identifier B10, and dynamic information of the administrator information. The identifier B10 indicates that the administrator information associated with the identifier B10 is information regarding the administrator who manages the mobile body 30. The dynamic information of the administrator information includes an evaluation score B10 regarding the administrator, a body operation achievement, the number of bodies that the administrator holds, and the like.

The user information includes an identifier C10, and dynamic information of the user information. The identifier C10 indicates that the user information associated with the identifier C10 is information regarding the user who manipulates the mobile body 30. The dynamic information of the user information includes an evaluation score C10 regarding the user, a movement achievement (that is, a manipulation achievement), an accident history regarding the manipulation by the user, and the like.

The dynamic information stored in the update information generation apparatus 11 has been described above. The dynamic information stored in the update information generation apparatus 11 corresponds to dynamic information of the remote identification information included in the mobile body 30 that will be described later. Further, the identifier included in the dynamic information stored in the update information generation apparatus 11 is used to associate this dynamic information with static information included in the static information management apparatus 20 described later.

### (Static Information)

Referring next to FIG. 8, static information stored in the static information management apparatus 20 will be described. FIG. 8 is a diagram showing an example of the static information. The static information shown in FIG. 8 includes the body information, the administrator information, and the user information that correspond to the dynamic information shown in FIG. 7.

The body information includes update information, and static information of the body information. The update information includes an identifier A10 and an evaluation score A10. The identifier A10 and the evaluation score A10 correspond to the identifier A10 and the evaluation score A10 of the body information included in the dynamic information shown in FIG. 7. The static information included in the body information includes, for example, a validity period of an operation qualification for operating the mobile body 30, the body number, and the weight.

The administrator information includes update information, and static information of the administrator information. The update information corresponds to the identifier B10 and the evaluation score B10 of the administrator information included in the dynamic information shown in FIG. 7. The static information included in the administrator information includes, for example, a validity period of a management qualification regarding the administrator, the name or the title of the administrator, and the address or the location of the administrator.

The user information includes update information, and static information of the user information. The update information corresponds to the identifier C10 and the evaluation score C10 of the user information included in the dynamic information shown in FIG. 7. The static information included in the user information includes a validity period of a usage qualification of the user, the user's name, the user's address, and the like.

The static information stored in the static information management apparatus 20 has been described above. The static information stored in the static information management apparatus 20 corresponds to static information of the remote identification information included in the mobile body 30 described later. Further, the identifiers included in the static information stored in the static information management apparatus 20 are used to associate this static information with the aforementioned dynamic information included in the update information generation apparatus 11. Note that the update information included in the static information shown in FIG. 8 is used to update the static information. That is, the static information does not necessarily include the update information. Likewise, since the update information is used to update the static information, the update information does not necessarily store, for example, an evaluation score.

### (Remote Identification Information)

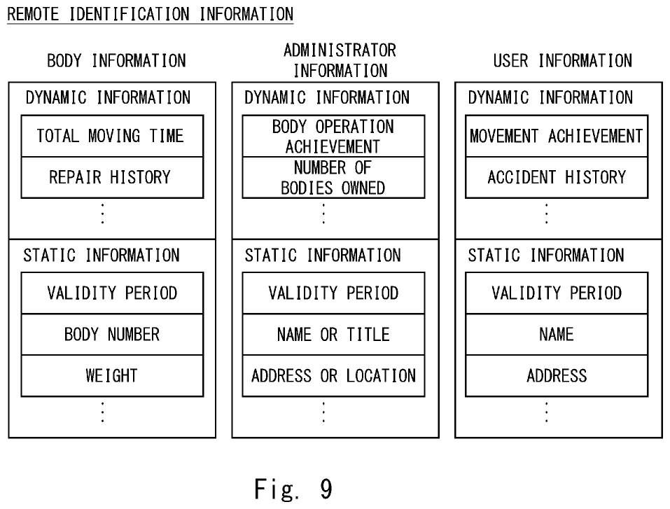

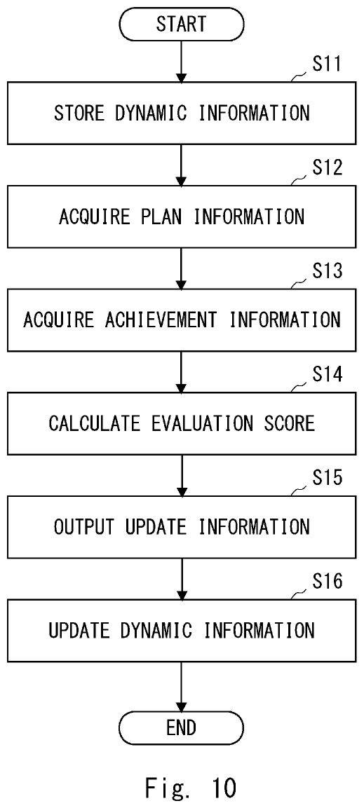

Referring next to FIG. 9, remote identification information included in the mobile body 30 will be described. FIG. 9 is a diagram showing an example of the remote identification information. The remote identification information includes body information, administrator information, and user information.

The body information includes dynamic information and static information. The dynamic information of the body information includes a total moving time, a repair history, and the like. The static information of the body information includes a validity period of an operation qualification for operating the mobile body 30 regarding the body information, the body number, the weight, and the like.

The administrator information includes dynamic information and static information. The dynamic information of the administrator information includes a body operation achievement, the number of bodies that the administrator has, and the like. The static information of the administrator information includes a validity period of a management qualification regarding the mobile body 30 regarding the administrator information, the name or the address of the administrator, the address or the location of the administrator, and the like.

The user information includes dynamic information and static information. The dynamic information of the user information includes a movement achievement of a user, an accident history, and the like. The static information of the user information includes a validity period of a usage qualification for using the mobile body 30 regarding user information, the user's name, the user's address, and the like.

The remote identification information has been described above. The dynamic information included in the remote identification information that the mobile body 30 has corresponds to the dynamic information stored in the update information generation apparatus 11. The mobile body 30 may supply the dynamic information that it stores to the update information generation apparatus 11. Further, the static information included in the remote identification information corresponds to static information stored in the static information management apparatus 20. The mobile body 30 may supply the static information stored therein to the static information management apparatus 20. Note that the mobile body 30 may acquire the dynamic information stored in the update information generation apparatus 11. Likewise, the mobile body 30 may acquire the static information stored in the static information management apparatus 20.

Referring next to FIG. 10, processing executed by the update information generation apparatus 11 will be described. FIG. 10 is a flowchart of an update direction according to the second example embodiment. Steps S11 to S15 in the flowchart shown in FIG. 10 are the same as those in the flowchart shown in FIG. 2. The flowchart shown in FIG. 10 is different from the flowchart shown in FIG. 2 in that Step S16 is performed after Step S15 in the flowchart shown in FIG. 10.

In Step S15, the output unit 114 of the update information generation apparatus 11 outputs update information including an evaluation score and an identifier to the static information management apparatus (Step S15).

Next, the dynamic information update unit 115 included in the update information generation apparatus 11 updates the dynamic information (Step S16). At this time, the dynamic information update unit 115 updates the dynamic information in such a way that the dynamic information includes the evaluation score included in the update information. That is, the evaluation score included in the dynamic information is overwritten with the latest one. After the dynamic information update unit 115 updates the update information, the update information generation apparatus 11 ends a series of processing.

The update information generation method executed by the update information generation apparatus 11 has been described above. Note that the update information generation method executed by the update information generation apparatus 11 is not limited to the aforementioned configuration. For example, Step S16 may be executed between Step S14 and Step S15. Step S15 and Step S16 may be executed in parallel with each other.

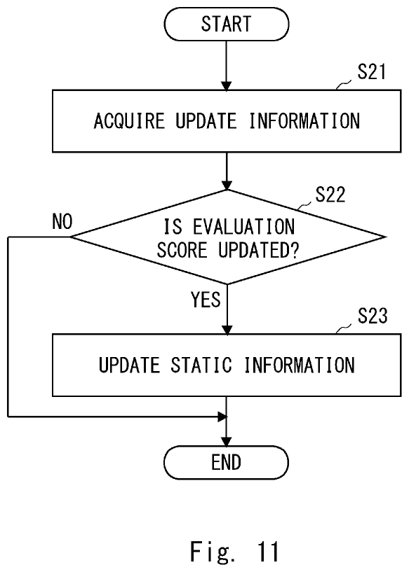

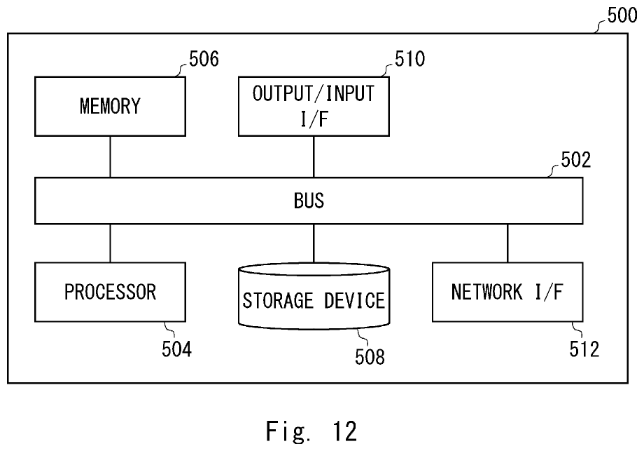

Referring next to FIG. 11, processing executed by the static information management apparatus 20 will be described. FIG. 11 is a flowchart showing a static information managing direction according to the second example embodiment. The flowchart shown in FIG. 11 is processing executed by the static information management apparatus 20. The flowchart shown in FIG. 11 is started, for example, by the static information management apparatus 20 receiving update information from the update information generation apparatus 11.

First, the update information acquisition unit 211 acquires update information supplied from the update information generation apparatus 11 (Step S21). The update information acquisition unit 211 supplies the acquired update information to the static information update unit 212.

Next, the static information update unit 212 determines, from the received update information, whether or not the evaluation score is updated (Step S22). When it is not determined that the evaluation score of the received update information is updated (Step S22: NO), the static information management apparatus 20 ends the series of processing. On the other hand, when it is determined that the evaluation score of the received update information is updated (Step S22: YES), the static information update unit 212 updates static information (Step S23). Then, after the static information update unit 212 updates the static information, the static information management apparatus 20 ends the series of processing.

The second example embodiment has been described above. Note that, in the aforementioned qualification information management system 1, the update information generation apparatus 11 and the static information management apparatus 20 may be managed by entities different from each other and may cooperate with each other. Further, in the qualification information management system 1, the update information generation apparatus 11 and the static information management apparatus 20 may be connected to each other via the network other than the network N1 or communication means. Further, in the qualification information management system 1, the update information generation apparatus 11 and the static information management apparatus 20 may be one apparatus that functions integrally.

The contents of the remote identification information, the dynamic information, and the static information are not limited to the aforementioned information items. For example, the body information, the administrator information, and the user information included in the remote identification information, the dynamic information, and the static information may be managed separately from one another. Further, for example, the remote identification information, the dynamic information, and the static information may include only one of the body information, the administrator information, and the user information.

The calculation unit 113 of the update information generation apparatus 11 calculates an evaluation score using the plan information, the achievement information, and the dynamic information. However, this is merely an example. For example, the calculation unit 113 may have a function of decreasing the evaluation score when the achievement information indicates that a predetermined safety violation has been committed. More specifically, when, for example, the update information generation apparatus 11 has detected achievement information indicating that the mobile body 30 has existed in an entry prohibited region for a predetermined period of time or longer, the calculation unit 113 may set the evaluation score to be a low value in accordance with the achievement information. Further, when the static information management apparatus 20 has received the update information including the evaluation score, the static information management apparatus 20 may update, for example, the information to invalidate the qualification regarding the administrator or the user. In this manner, the qualification information management system 1 is able to update the qualification information even in a situation where the plan information is not taken into account.

As described above, according to the second example embodiment, it is possible to provide an update information generation apparatus, a qualification information management system, an update information generation method, and a program for suitably managing qualification information.

The aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), CD-Read Only Memory (ROM), CD-R, CD-R/W, and semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### Example of Hardware Configuration

Hereinafter, a case in which each functional configuration of the update information generation apparatus and the static information management apparatus according to the present disclosure is implemented by a combination of hardware with software will be described.

FIG. 12 is a block diagram illustrating a hardware configuration of a computer. The update information generation apparatus and the static information management apparatus according to the present disclosure can implement the aforementioned functions by an information processing terminal 500 including a hardware configuration shown in FIG. 12. The information processing terminal 500 may be a portable computer such as a smartphone or a tablet terminal or may be a stationary computer such as a PC. The information processing terminal 500 may be a special-purpose computer designed to implement each of the apparatuses, or may be a general-purpose computer. The information processing terminal 500 is able to implement a desired function as a predetermined request is installed therein.

The information processing terminal 500 includes a bus 502, a processor 504, a memory 506, a storage device 508, an input/output interface (I/F) 510, and a network interface (I/F) 512. The bus 502 is a data transmission path for enabling the processor 504, the memory 506, the storage device 508, the input/output interface 510, and the network interface 512 to transmit and receive data among them. However, the method for connecting the processor 504 and the like to one another is not limited to the bus connection.

The processor 504 may be any type of processor such as a CPU, a GPU or an FPGA. The memory 506 is a main memory unit that is implemented using a Random Access Memory (RAM) or the like.

The storage device 508 is an auxiliary storage device that is implemented with a hard disk, an SSD, a memory card, or a Read Only Memory (ROM). The storage device 508 stores a program for achieving a desired function. The processor 504 loads this program into the memory 506 to execute the loaded program, thereby implementing each functional configuration unit of each apparatus.

The input/output interface 510 is an interface for connecting the information processing terminal 500 to an input/output device. An input device such as a keyboard and an output device such as a display device are connected, for example, to the input/output interface 510.

The network interface 512 is an interface for connecting the information processing terminal 500 to a network.

Note that the present invention is not limited to the aforementioned example embodiments and may be changed as appropriate without departing from the spirit of the present invention.

The whole or part of the example embodiments disclosed above can be described as, but not limited to, the following supplementary notes.

### (Supplementary Note 1)

An update information generation apparatus comprising:
a dynamic information storage unit configured to store dynamic information on a qualification regarding a mobile body;
a plan information acquisition unit configured to acquire plan information regarding an operation plan for operating the mobile body;
an achievement information acquisition unit configured to acquire achievement information that corresponds to the plan information of the mobile body;
a calculation unit configured to calculate an evaluation score for updating static information on the qualification based on the dynamic information, the plan information, and the achievement information; and
an output unit configured to output update information including the evaluation score and an identifier to a static information management apparatus that manages the static information.

### (Supplementary Note 2)

The update information generation apparatus according to Supplementary Note 1, wherein
the dynamic information storage unit stores the dynamic information including user information regarding a usage achievement of a user who has a usage qualification for using the mobile body, and
the calculation unit calculates the evaluation score of the user.

### (Supplementary Note 3)

The update information generation apparatus according to Supplementary Note 1, wherein
the dynamic information storage unit stores the dynamic information including administrator information regarding a managing achievement of an administrator having a management qualification regarding the mobile body, and
the calculation unit calculates the evaluation score of the administrator.

### (Supplementary Note 4)

The update information generation apparatus according to Supplementary Note 1, wherein
the dynamic information storage unit stores the dynamic information including a mobile body score regarding an operation qualification for operating the mobile body, and
the calculation unit calculates the evaluation score of the mobile body.

### (Supplementary Note 5)

The update information generation apparatus according to any one of Supplementary Notes 1 to 4, further comprising a dynamic information update unit configured to update the dynamic information based on the achievement information and the calculated evaluation score.

### (Supplementary Note 6)

The update information generation apparatus according to Supplementary Note 5, wherein the calculation unit updates the evaluation score with a value that becomes higher as the difference between the plan information and the achievement information becomes smaller, and updates the evaluation score with a value that becomes lower as the difference between the plan information and the achievement information becomes larger.

### (Supplementary Note 7)

A qualification information management system further comprising:
the update information generation apparatus according to any one of Supplementary Notes 1 to 6; and
a static information management apparatus comprising a static information storage unit configured to store the static information on the qualification and a static information update unit configured to update the static information regarding the identifier based on the update information received from the update information generation apparatus.

### (Supplementary Note 8)

The qualification information management system according to Supplementary Note 7, wherein
in the static information management apparatus,
the static information storage unit stores the static information including a validity period of the qualification, and
the update unit updates the validity period based on the evaluation score.

### (Supplementary Note 9)

The qualification information management system according to Supplementary Note 8, wherein the update unit extends the validity period when the evaluation score is equal to or larger than a first threshold and shortens the validity period when the evaluation score is smaller than a second threshold which is lower than the first threshold.

### (Supplementary Note 10)

The qualification information management system according to any one of Supplementary Notes 7 to 9, wherein
in the static information management apparatus,
the static information storage unit stores the static information including the validity of the qualification, and
the update unit updates information indicating whether or not the qualification is valid based on the evaluation score.

### (Supplementary Note 11)

The qualification information management system according to Supplementary Note 10, wherein the update unit updates information with information indicating that the qualification is invalid when the evaluation score is smaller than a third threshold.

### (Supplementary Note 12)

An update method, wherein
a computer performs the following processing of:
storing dynamic information on a qualification regarding a mobile body;
acquiring plan information regarding an operation plan for operating the mobile body;
acquiring achievement information that corresponds to the plan information of the mobile body;
calculating an evaluation score for updating static information on the qualification based on the dynamic information, the plan information, and the achievement information; and
outputting the evaluation score and an identifier to a static information management apparatus that manages the static information.

### (Supplementary Note 13)

A program for causing a computer to execute an update method comprising:
storing dynamic information on a qualification regarding a mobile body;
acquiring plan information regarding an operation plan for operating the mobile body;
acquiring achievement information that corresponds to the plan information of the mobile body;
calculating an evaluation score for updating static information on the qualification based on the dynamic information, the plan information, and the achievement information; and
outputting the evaluation score and an identifier to a static information management apparatus that manages the static information.

This application is based upon and claims the benefit of priority from Japanese Patent Application No. 2021-062051, filed on Mar. 31, 2021, the disclosure of which is incorporated herein in its entirety by reference.

### REFERENCE SIGNS LIST

1 QUALIFICATION INFORMATION MANAGEMENT SYSTEM
10 UPDATE INFORMATION GENERATION APPARATUS
11 UPDATE INFORMATION GENERATION APPARATUS
20 STATIC INFORMATION MANAGEMENT APPARATUS
30 MOBILE BODY
40 MANIPULATION TERMINAL
50 INFORMATION PROCESSING TERMINAL
111 PLAN INFORMATION ACQUISITION UNIT
112 ACHIEVEMENT INFORMATION ACQUISITION UNIT
113 CALCULATION UNIT
114 OUTPUT UNIT
115 DYNAMIC INFORMATION UPDATE UNIT
120 DYNAMIC INFORMATION STORAGE UNIT
211 UPDATE INFORMATION ACQUISITION UNIT
212 STATIC INFORMATION UPDATE UNIT
220 STATIC INFORMATION STORAGE UNIT
311 COMMUNICATION UNIT
312 CAMERA
313 SENSOR GROUP
314 CONTROL UNIT
315 DRIVE UNIT
320 STORAGE UNIT
500 COMPUTER
502 BUS
504 PROCESSOR
506 MEMORY
508 STORAGE DEVICE
510 OUTPUT/INPUT I/F
512 NETWORK I/F

What is claimed is:

1. An update information generation apparatus comprising:
at least one memory configured to store dynamic information on a qualification regarding a mobile body and instructions, and;
at least one processor configured to execute the instructions to;
acquire plan information regarding an operation plan for operating the mobile body;
acquire achievement information that corresponds to the plan information of the mobile body;
calculate an evaluation score for updating static information on the qualification based on the dynamic information, the plan information, and the achievement information; and
output update information including the evaluation score and an identifier to a static information management apparatus that manages the static information.

2. The update information generation apparatus according to claim 1, wherein
the at least one memory is configured to store the dynamic information including user information regarding a usage achievement of a user who has a usage qualification for using the mobile body, and
the at least one processor is further configured to execute the instruction to calculate the evaluation score of the user.

3. The update information generation apparatus according to claim 1, wherein
the at least one memory is configured to store the dynamic information including the evaluation score of the qualification, and
the at least one processor is further configured to execute the instruction to update the evaluation score based on the plan information and the achievement information.

4. The update information generation apparatus according to claim 1, wherein
the at least one memory is configured to store the dynamic information including a mobile body score regarding an operation qualification for operating the mobile body, and
the at least one processor is further configured to execute the instruction to calculate the evaluation score of the mobile body.

5. The update information generation apparatus according to claim 1, wherein
the at least one processor is further configured to execute the instruction to update the dynamic information based on the achievement information and the calculated evaluation score.

6. The update information generation apparatus according to claim 5, wherein
the at least one processor is further configured to execute the instructions to update the evaluation score with a value that becomes higher as the difference between the plan information and the achievement information becomes smaller, and
update the evaluation score with a value that becomes lower as the difference between the plan information and the achievement information becomes larger.

7. A qualification information management system comprising:
the update information generation apparatus according to claim 1; and
a static information management apparatus comprising:
at least one memory configured to store the static information on the qualification; and at least one processor configured to execute the instruction to update the static information regarding the identifier based on the update information received from the update information generation apparatus.

8. The qualification information management system according to claim 7, wherein
in the static information management apparatus,
the at least one memory is configured to store the static information including a validity period of the qualification, and
the at least one processor is further configured to execute the instruction to update the validity period based on the evaluation score.

9. The qualification information management system according to claim 8, wherein
in the static information management apparatus,
the at least one processor is further configured to execute the instructions to:
extend the validity period when the evaluation score is equal to or larger than a first threshold; and
shorten the validity period when the evaluation score is smaller than a second threshold which is lower than the first threshold.

10. The qualification information management system according to claim 7, wherein
in the static information management apparatus,
the at least one memory is configured to store the static information including the validity of the qualification, and
the at least one processor is further configured to execute the instruction to update information indicating whether or not the qualification is valid based on the evaluation score.

11. The qualification information management system according to claim 10, wherein
in the static information management apparatus,
the at least one processor is further configured to execute the instruction to update information with information indicating that the qualification is invalid when the evaluation score is smaller than a third threshold.

12. An update information generation method, wherein
a computer performs the following processing of:
storing dynamic information on a qualification regarding a mobile body;
acquiring plan information regarding an operation plan for operating the mobile body;
acquiring achievement information that corresponds to the plan information of the mobile body;
calculating an evaluation score for updating static information on the qualification based on the dynamic information, the plan information, and the achievement information; and
outputting update information including the evaluation score and an identifier to a static information management apparatus that manages the static information.

13. (canceled)

14. The update information generation method according to claim 12, wherein
the computer further performs the processing of:
storing the dynamic information including user information regarding a usage achievement of a user who has a usage qualification for using the mobile body, and
calculating the evaluation score of the user.

15. The update information generation method according to claim 12, wherein
the computer further performs the processing of:
storing the dynamic information including the evaluation score of the qualification, and
updating the evaluation score based on the plan information and the achievement information.

16. The update information generation method according to claim 12, wherein
the computer further performs the processing of:
storing the dynamic information including a mobile body score regarding an operation qualification for operating the mobile body, and
calculating the evaluation score of the mobile body.

17. A non-transitory computer readable medium storing a program for causing a computer to execute an update information generation method comprising:
storing dynamic information on a qualification regarding a mobile body;
acquiring plan information regarding an operation plan for operating the mobile body;
acquiring achievement information that corresponds to the plan information of the mobile body;
calculating an evaluation score for updating static information on the qualification based on the dynamic information, the plan information, and the achievement information; and
outputting update information including the evaluation score and an identifier to a static information management apparatus that manages the static information.

18. The non-transitory computer readable medium according claim 17, wherein the update information generation method comprising:
storing the dynamic information including user information regarding a usage achievement of a user who has a usage qualification for using the mobile body, and
calculating the evaluation score of the user.

19. The non-transitory computer readable medium according claim 17, wherein the update information generation method comprising:
storing the dynamic information including the evaluation score of the qualification, and
updating the evaluation score based on the plan information and the achievement information.

20. The non-transitory computer readable medium according claim 17, wherein the update information generation method comprising:
storing the dynamic information including a mobile body score regarding an operation qualification for operating the mobile body, and
calculating the evaluation score of the mobile body.
